(19) United States
(12) Patent Application Publication
(10) Pub. No.: US 2007/0231497 A1
(43) Pub. Date: Oct. 4, 2007

(54) Apparatus and method for coating polyimide layer

(75) Inventors: Ki Du Cho, Gyeongsangbuk-do (KR); Bong Chul Kim, Daegu (KR); Hui Jae Lee, Daejeon (KR); Sung Ja Kim, Daegu (KR); Hwang Un Seo, Busan (KR); Hang Sup Cho, Chungcheongnam-do (KR); Eun Mi Kim, Daegu (KR)

Correspondence Address: SEYFARTH SHAW, LLP, 815 CONNECTICUT AVENUE, N.W., SUITE 500, WASHINGTON, DC, 20006, US

(73) Assignee: LG.PHILIPS LCD CO., LTD., Seoul (KR)

(21) Appl. No.: 11/647,375

(22) Filed: Dec. 29, 2006

(30) Foreign Application Priority Data
Mar. 29, 2006 (KR) 10-2006-0028406

(51) Int. Cl. B05D 1/02; B05D 5/00

(52) U.S. Cl. 427/427.1; 427/258; 118/46

(57) ABSTRACT

An apparatus for coating polyimide layer includes a print table, an inkjet head, and a polyimide liquid supply tank, wherein the inkjet head is configured to jet the polyimide liquid in a scan-coating and be shifted by a predetermined shift pitch in a direction until 2N times of scan-coating occurs in which N≧2 and N is a natural number. A method for coating polyimide layer includes placing a substrate, loading a polyimide liquid vessel into a polyimide liquid supply tank, jetting the polyimide liquid onto the substrate in a scan-coating, repeating the jetting the polyimide liquid onto the substrate in a scan-coating and the shifting the inkjet head by a predetermined shift pitch until 2N times of scan-coating occurs in which N≧2 and N is a natural number.

This application claims the benefit of Korean Patent Application No. 2006-0028406 filed in Korea on Mar. 29, 2006, which is hereby incorporated by reference in its entirety.

### BACKGROUND OF THE INVENTION

1. Field of the Invention

Embodiments of the invention relates to an apparatus and method for coating a polyimide layer, and more particularly, to an apparatus and method for coating a polyimide layer through an ink-jet coating method.

2. Background of the Related Art

A liquid crystal display (LCD) device is an apparatus for displaying a desired image by adjusting quantity of light reaching a color filter substrate. The adjustment of the quantity of light is accomplished by changing intermolecular orientation of liquid crystal molecules interposed between a transparent insulating substrate serving as the color filter substrate and an array substrate. One type of LCD device is a thin film transistor liquid crystal display (TFT LCD) device, which uses thin film transistors (TFTs) as switching elements.

In general, an LCD device includes an LCD panel for displaying an image and a driver for driving the LCD panel by applying driving signals to the LCD panel. The LCD panel includes a color filter substrate and an array substrate bonded to each other with a predetermined gap therebetween. A layer of liquid crystal molecules is in the gap between the color filter substrate and the array substrate. The color filter substrate and the array substrate of the LCD panel are manufactured through a plurality of masking processes. Polyimide layers are formed on respective substrates after finishing the masking processes and before the substrates are bonded to each other. The polyimide layers are used as alignment films to arrange the liquid crystal molecules in a predetermined direction.

The polyimide layers can be coated on the substrates through a variety of methods, such as a spin-coating method, a spray-coating method, and an inkjet-coating method. Of the coating methods, the inkjet-coating method is the quickest and easiest to apply because of the use of an inkjet coating apparatus. A plurality of inkjet heads is used in an inkjet coating apparatus to jet polyimide liquid onto the substrates.

FIG. 1 is a view for explaining a method of scanning a substrate using a polyimide layer coating apparatus according to the related art, and FIG. 2 illustrates a two(2) scan-coating method. The two(2)-scan-coating method refers a method in which a polyimide layer is formed by coating a substrate two times with an inkjet head that scans across the substrate so as to put a line of polyimide down. That is, after a scan-coating is performed a first time, an inkjet head shifts by a predetermined pitch PS, and then a scan-coating is performed a second time. For example, given that a nozzle pitch P1 is set to 1 pitch and an offset pitch P2 is set to a 0.5 pitch (0.371 mm), a shift pitch PS is set to 1.5 pitch (1.114 mm).

As shown in FIG. 1, respective nozzles N1, N2, N3, N4, N5, N6, . . . provided in the inkjet head are disposed at a first position to jet polyimide liquid during a first scan-coating, and the nozzles N1, N2, N3, N4, N5, N6, . . . jet polyimide liquid at a second position distanced from the first position by a shift pitch during a second scan-coating. For example, the nozzle N1 jets polyimide liquid when it is disposed at the first position during the first scan-coating and jets polyimide liquid when it is disposed at the second position A12 during the second scan-coating.

FIG. 2 and FIG. 3 are views for explaining the drawbacks of the method shown in FIG. 1. That is, FIG. 2 and FIG. 3 illustrate the problems which occur in a region B1 when the nozzle N1 is clogged. As shown in FIG. 2, in the case in which no nozzle is clogged, the nozzles N2 and N3 jet polyimide liquid in a state in which they are disposed at respective positions B11 and B13 during the first scan-coating, and the Nozzle N1 jets polyimide liquid to the region B1 while it is disposed at a position B12 during a second scan-coating because the inkjet head shifts by a shift pitch after the first scan-coating. However, if the nozzle N1 of the inkjet head is clogged, even after the second scan-coating is finished, polyimide liquid is not deposited at the area B12, as shown in FIG. 3. Accordingly, coating areas for the other nozzles N2 and N3 increase. In this case, since diffusivity of polyimide liquid is limited, a non-coated area can appear. Due to the diffusivity limitation of polyimide liquid, uniformity of film thickness deteriorates at a region in which no-jetting occurred, for example, the region B12. This non-coated area appears as vertical line blemish in an LCD panel.

### SUMMARY OF THE INVENTION

Accordingly, embodiments of the invention is directed to an apparatus and method for coating a polyimide layer that substantially obviates one or more of the problems due to limitations and disadvantages of the related art.

An object of embodiments of the invention is to provide an apparatus and method for coating polyimide layer, which prevent a no-coating fault caused due to poor diffusivity of polyimide liquid.

Another object of embodiments of the invention is to provide an apparatus and method for coating polyimide layer, which prevent vertical line blemish caused due to no-jetting of polyimide liquid from clogged nozzles.

Another object of embodiments of the invention is to provide an apparatus and method for coating polyimide layer, which prevents non-uniformity in the film thickness of the polyimide coating.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

According to an aspect of embodiments of the invention, there is provided an apparatus for coating a polyimide layer including: a print table to receive a substrate thereon, an inkjet head having a plurality of nozzles for jetting polyimide liquid onto the substrate, and a polyimide liquid supply tank with polyimide liquid therein, wherein the inkjet head is configured to jet the polyimide liquid in a scan-coating and be shifted by a predetermined shift pitch in a direction until 2N times of scan-coating occurs in which N≧2 and N is a natural number.

According to another aspect of embodiments of the invention, there is provided a method for coating a polyimide layer that includes placing a substrate on a print table, loading a polyimide liquid into a polyimide liquid supply tank, jetting the polyimide liquid onto the substrate in a scan-coating through a plurality of nozzles provided to the inkjet head after the polyimide liquid is supplied to the inkjet head installed over the print table, and shifting the inkjet head by a predetermined shift pitch, repeating the jetting the polyimide liquid onto the substrate in a scan-coating and the shifting the inkjet head by a predetermined shift pitch until 2N times of scan-coating occurs in which N≧2 and N is a natural number.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention. In the drawings:

FIG. 1 is a view for explaining a method of scanning using a polyimide layer coating apparatus according to the related art;

FIG. 2 and FIG. 3 are views for illustrating technical problems of the apparatus and method shown in FIG. 1;

FIG. 4 is a schematic view illustrating an apparatus for coating a polyimide layer according to an embodiment of the invention;

FIG. 5 is a view for explaining a method of scanning using the apparatus shown in FIG. 4;

FIG. 6 and FIG. 7 are views for explaining advantageous effects of the scanning method shown in FIG. 5; and

FIG. 8 is a flowchart showing a method of coating a polyimide layer according to another embodiment of the invention.

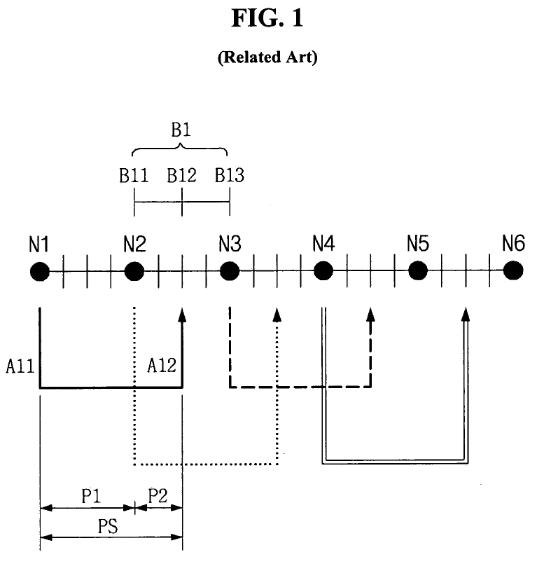

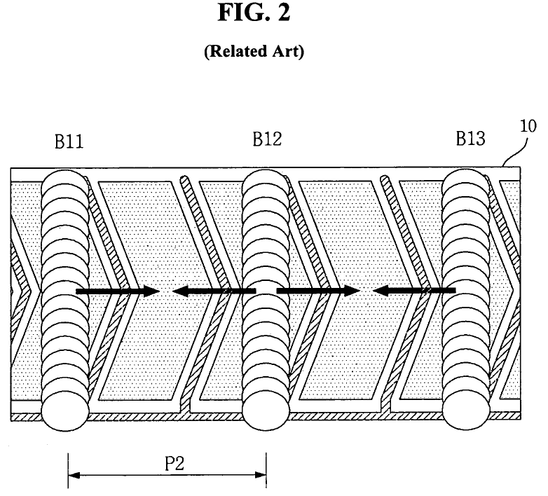

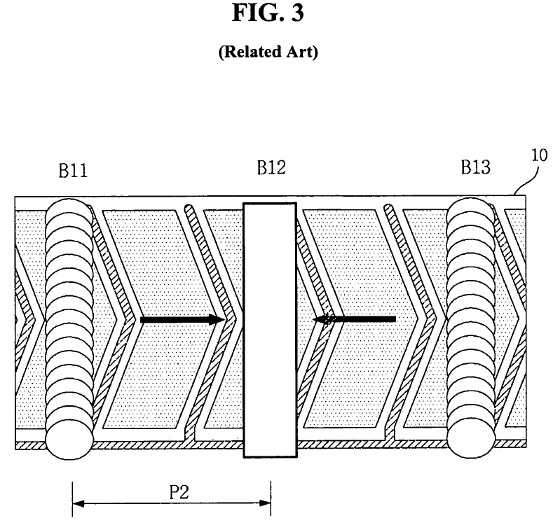

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

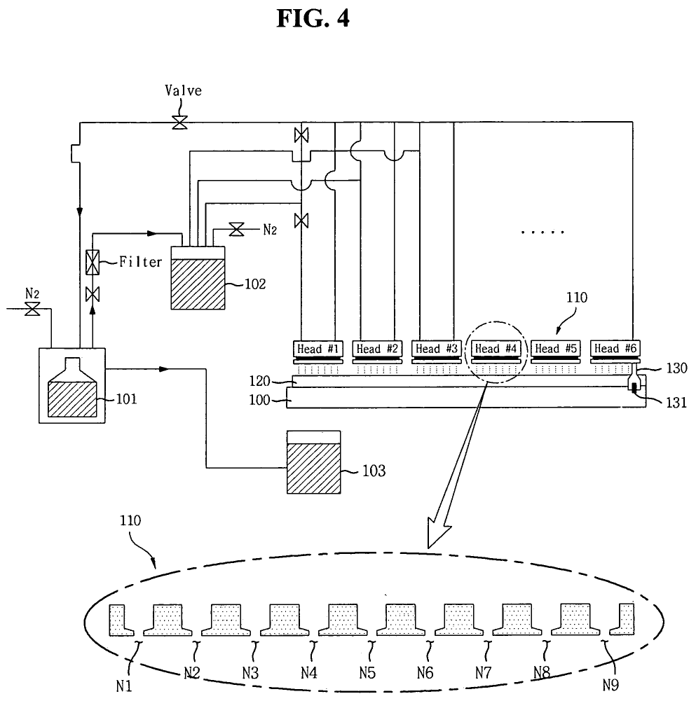

FIG. 4 is a schematic view illustrating an apparatus for coating a polyimide layer according to an embodiment of the invention. As shown in FIG. 4, the apparatus for coating a polyimide layer according to an embodiment of the invention includes a print table 100, an inkjet head 110, a polyimide liquid supply tank 102, and a wiper 130. More specifically, the polyimide layer coating apparatus has the print table 100 on which the substrate 120 to be coated with a polyimide layer is placed and fixed. The substrate 120 can either be a color filter substrate or a thin film transistor array substrate of an LCD device.

A plurality of inkjet heads 110 are arranged in parallel with each other over the substrate 120, and each inkjet head 110 is connected to the polyimide liquid supply tank 102. The polyimide liquid supply tank 102 receives polyimide liquid from a pressure tank 101, and supplies the polyimide liquid to the inkjet head 110 at a predetermined constant pressure and flow rate. Polyimide liquid has the advantage of being heat resistant, chemically stable and high reliability.

A gas connection pipe provides nitrogen (N₂) to the pressure tank 101. A polyimide liquid recovery connection pipe provides polyimide liquid recovered from the inkjet head to the pressure tank 101. A polyimide supply connection pipe through which polyimide liquid is provide to the polyimide supply tank 102 through a filter is connected to the pressure tank 101. A back pressure supply connection pipe for providing back pressure to a cleaning liquid supply tank 103 is also connected to the pressure tank 101. Further, each connection pipe be provided with a valve for controlling amount of the content passing through the connection pipes and the pressure in the connection pipes.

Over the pressure tank 101, connection pipes such s a gas supply pipe through which nitrogen (N₂) passes, a polyimide liquid recovery pipe through which the polyimide liquid is recovered from the inkjet head, and a polyimide supply pipe through which polyimide liquid passes toward to the polyimide supply tank 102 by a pressure caused due to the nitrogen gas (N₂) input from the gas supply pipe via a filter. Further, each connection pipe is provided with a valve for controlling pressure and amount of the content passing through the connection pipe.

The inkjet head 110 has a plurality of nozzles N1, N2, N3, N4, N5, N6, N7, N8, N9, . . . , and jets polyimide liquid onto the substrate 120 through the nozzles while scan-coating the substrate 120 in a predetermined direction over the print table 100. The inkjet head 110 shifts by a predetermined shift pitch determined based on the number of times of scanning, defined as 2N(N≧2, N is a natural number) in a direction. The shift pitch is inversely proportional to the number of times of scan-coating. While the number of times of scan-coating is fixed to two (2) in the related art, the number of times of scan-coating is variable in the method according to embodiments of the invention. That is, the shift pitch of the nozzles N1, N2, N3, N4, N5, N6, N7, N8, N9, . . . , of the inkjet head 110 can be adjusted or, more particularly, can be decreased to a proper value by varying the number of times of scan-coating. Accordingly, the leveling width determined by the diffusivity of polyimide liquid is decreased, and a no-coated fault caused due to poor diffusivity of polyimide liquid can be prevented.

After jetting the polyimide layer onto the substrate, the jetting surface of the inkjet head 110 is wet with the polyimide liquid. The polyimide liquid remaining on the jetting surface of the inkjet head 110 is then removed through a wiping method. Accordingly, the jetting surface of the inkjet head is maintained in a state such that polyimide liquid can be jetted uniformly.

The wiper 130 is installed in a manner such that it can move along a moving shaft 131 while the wiper 130 maintains contact with the jetting surfaces of the inkjet 110, so that the wiper 130 can perform a wiping operation. After finishing the wiping operation, the wiper 130 rotates 180 degrees from a wiping position so as to be dipped into a cleaning liquid in the cleaning liquid supply tank 103, and then further rotates another 180 degrees to go back to the wiping position. Further, the wiper 130 can be dipped and wiped again before another wiping operation.

If the polyimide liquid residue remains on the surface of the wiper 130 after the wiping operation, a subsequent wiping operation against the inkjet head 110 may not adequately clean the jetting surfaces of the inkjet 110 such that polyimide liquid may not jet properly. This problem is solved by using the cleaning liquid supply tank 103 that supplies cleaning liquid needed to clean the wiper 130 by receiving a cleaning liquid vessel filled with cleaning liquid therein. The cleaning liquid may be made from N-methyl pyrrolidone, which is an imide-based polar solvent.

Since the polyimide liquid supply tank 102 and the cleaning liquid supply tank 103 have the same structure in which a desired liquid is loaded in the tank by receiving a vessel filled with the desired liquid therein, the polyimide liquid supply tank 102 and the cleaning liquid supply tank 103 can share a single tank. That is, the single tank receives different vessels filled with different liquids in turns according to the process sequence.

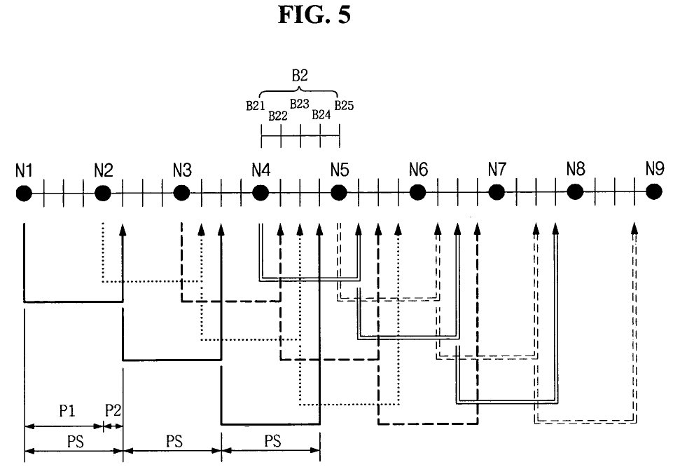

FIG. 5 is a view for explaining a method of scanning shown in FIG. 4. FIG. 5 shows the change of positions of the nozzles N1, N2, N3, N4, N5, N6, N7, N8, N9, . . . , of the inkjet head 110 when a four(4) scan-coating method is applied. In the four(4) scan-coating method, polyimide liquid is coated four times by scanning a jetting inkjet head four times across the substrate since the number of times of scanning is 4 because 2N=4). Accordingly, after performing one time of scan-coating, the inkjet head 110 shifts by a predetermined shift pitch PS, and then repeats the scan-coating operation.

The shift pitch is set to be reciprocal to the number of times of scanning, and more preferably the shift pitch may be set to a value corresponding to the sum of a nozzle pitch P1 of the nozzles N1, N2, N3, N4, N5, N6, N7, N8, N9, . . . , provided to the inkjet head and an offset pitch P2 which is a value defined as ½N of the nozzle pitch P1. For example, if the nozzle pitch P1 is 1 pitch and the offset pitch P2 is 0.25 pitch (0.186 mm), the shift pitch PS may be 1.25 pitch (0.928 mm).

As described above, according to embodiments of the invention, the leveling width of polyimide liquid is reduced by increasing the number of times of scan-coating and decreasing the shift pitch PS based on the number of times of scan-coating. Accordingly, it can be scan-coated in such manner that a predetermined region is coated by different adjacent nozzles. For example, in a region B2, the nozzles N4 and N5 jet polyimide liquid at respective positions B21 and B25 during a first time of scan-coating, the nozzle N3 jets polyimide liquid at a position B22 during a second time of scan-coating, the nozzle N2 jets polyimide liquid at a position B23 during a third time of scan-coating, and the nozzle N1 jets polyimide liquid at a position B24 during a fourth time of scan-coating.

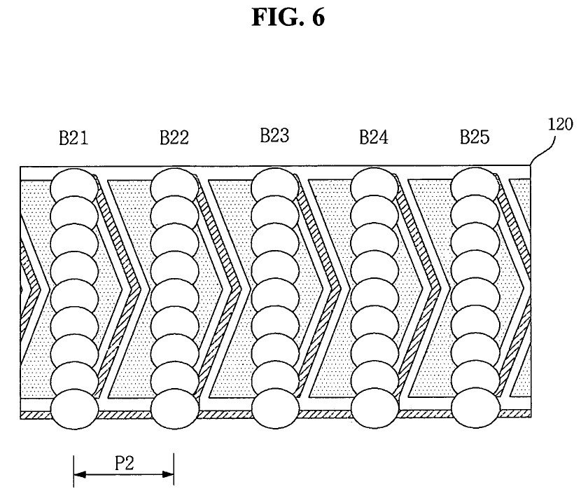

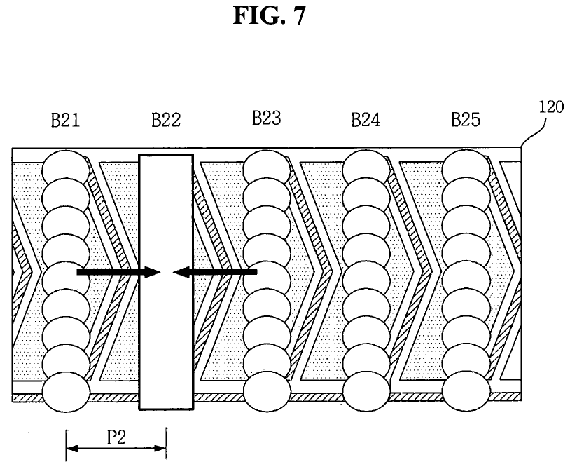

FIG. 6 and FIG. 7 are views illustrating the advantageous effect of the scan-coating method shown in FIG. 5. FIG. 6 and FIG. 7 illustrate the coating state of the region B2, in which FIG. 6 is the coating layer obtained in the case in which no nozzle is clogged, and FIG. 7 shows the coating layer obtained in the case in which the nozzle N3 is clogged. Referring to FIG. 6 and FIG. 7, when forming a polyimide layer through the four(4) scan-coating method, in the case in which one nozzle, for example nozzle N3, is clogged and no polyimide liquid is jetted through the nozzle N3 when coating the region B22, a no-coated area, which is caused due to no-jetting of polyimide liquid and which is needed to be coated by the other nozzles is reduce to 50% in comparison to the two(2) scan-coating method. Accordingly, a line blemish or no-coated fault due to no-jetting of polyimide liquid and poor diffusivity of polyimide disappear. Further, since the other nozzles N1, N2, N4 and N5 mitigate defect that can be caused due to the clogged nozzle N3 in the case in which adjacent nozzles are not consecutively clogged when coating a polyimide layer through the four(4) scan-coating method, a defect caused by the nozzle clogging can be reduced. In the above-described embodiments, it is assumed that N is set to 2 and the number of times of scanning is set to 4, but the value of N is variable and may be a variety of numbers such as 4, 5, . . . , so that the number of times of scan-coating can be set to a variety of numbers such as 8, 16, . . .

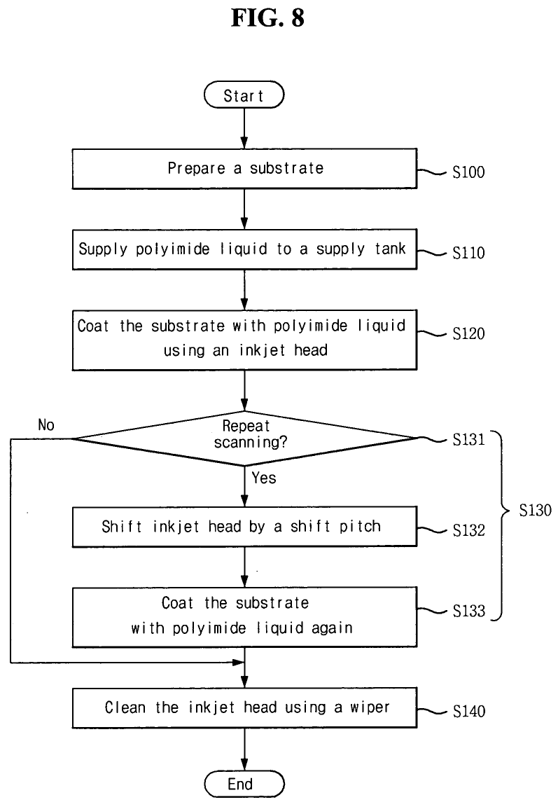

FIG. 8 is a flowchart showing a method of coating a polyimide layer according to another embodiment of the invention, and the method in FIG. 8 refers to the polyimide layer coating apparatus shown in FIG. 4 is used.

First, a substrate 120 is positioned and the affixed onto a print table 100, as described in step S100 of FIG. 8. The substrate 120 may be used as a thin film transistor array substrate or a color filter substrate of an LCD panel.

Next, a polyimide liquid vessel filled with polyimide liquid is loaded into a polyimide liquid supply tank 102, as described in step S110 of FIG. 8.

Then, the polyimide liquid is supplied to an inkjet head 110 installed over the print table 100, and the inkjet head 110 jets the polyimide liquid to the substrate, shifting to its position in a direction by a shift pitch determined based on the number of times of scan-coating, which is defined as 2N (N is a natural number, N≧2) after each time of scan-coating, as described in step S130 of FIG. 8. The shift pitch is set to be reciprocal to the number of times of scan-coating. Through the above-described steps, polyimide liquid is coated on the substrate 120.

The step S130 of FIG. 8 may include the following sub-steps of S131 through S133. The step S130 is repeated by the number of times of scan-coating. In sub-step S131, a determination is made on whether one more time of scanning operation should be performed based on the number of times of pre-set scan-coating, and if no more scan-coating operation is needed so that a next process step will be step S140. However, if another scan-coating operation is needed, a next step will be sub-step S132. In sub-step S132, the inkjet head 110 is shifted by the predetermined shift pitch set to correspond to the number of times of scan-coating, and sub-step S132 is followed by sub-step S133. In sub-step S133, a single scan-coating operation is performed to jet polyimide liquid onto the substrate 120.

As describe in step S140 of FIG. 8, a wiper 130 moves to be brought into contact with a jetting surface of the inkjet head 110, so that the wiper 130 can wipe off nozzles 111 of the inkjet head 110.

Next, a cleaning liquid vessel filled with cleaning liquid is loaded into a cleaning liquid supply tank 103, and the wiper 130 is rotated to be dipped into the cleaning liquid, so that the wiper 130 is cleaned. After that, the wiper 130 is rotated once more to be returned to its original position. The cleaning liquid may be N-methyl pyrrolidone, which is imide-based polar solvent.

As described above, embodiments of the invention make different nozzles which are not consecutive jet polyimide liquid to a predetermined region by increasing the number of times of scan-coating and decreasing the shift pitch. As a result, uniformity of film thickness is improved and the problems of no-coated fault or blemish caused due to no-jetting from clogged nozzles can be solved. The apparatus and method for coating a polyimide layer according to embodiments of the invention can increase the number of times of scan-coating and set a proper shift pitch based on the number of times of scan-coating. Accordingly, polyimide liquid spreads wide and the leveling width can be decreased. Further, the apparatus and method for coating a polyimide layer according to embodiments of the invention can diminish the problem of no-coated area caused due to poor spreading characteristic of polyimide liquid. Furthermore, the apparatus and method for coating a polyimide layer according to embodiments of the invention allow different nozzles to jet polyimide liquid to a predetermined region when there is a clogged nozzle, which is supposed to jet polyimide liquid in the same predetermined region. Accordingly, vertical line blemish caused due to no-jetting can be prevented and un-coated areas are decreased such that the uniformity of polyimide film thickness is improved.

It will be apparent to those skilled in the art that various modifications and variations can be made in the apparatus and method for coating a polyimide layer of embodiments of the invention without departing from the spirit or scope of the invention. Thus, it is intended that embodiments of the invention cover the modifications and variations of this invention provided they come within the scope of the appended claims and their equivalents.

What is claimed is:

1. An apparatus for coating a polyimide layer, comprising:
a print table to receive a substrate thereon;
an inkjet head having a plurality of nozzles for jetting polyimide liquid onto the substrate; and
a polyimide liquid supply tank with polyimide liquid therein;
wherein the inkjet head is configured to jet the polyimide liquid in a scan-coating and be shifted by a predetermined shift pitch in a direction until 2N times of scan-coating occurs in which N≧2 and N is a natural number.

2. The apparatus for coating polyimide layer according to claim 1, the shift pitch is inversely proportional to the number of times of scan-coating.

3. The apparatus for coating polyimide layer according to claim 1, wherein the shift pitch is set to a value that is the sum of a nozzle pitch between nozzles provided to the inkjet head and an offset pitch.

4. The apparatus for coating polyimide layer according to claim 3, wherein the offset pitch value is ½N of the nozzle pitch.

5. The apparatus for coating polyimide layer according to claim 1, wherein the N is two (2) such that the number of times of scan-coating is four (4).

6. The apparatus for coating polyimide layer according to claim 1, wherein the N is four (4) such that the number of times of scan-coating is eight (8).

7. A method for coating a polyimide layer, comprising:
placing a substrate on a print table;
loading a polyimide liquid into a polyimide liquid supply tank;
jetting the polyimide liquid onto the substrate in a scan-coating through a plurality of nozzles provided to the inkjet head after the polyimide liquid is supplied to the inkjet head installed over the print table; and
shifting the inkjet head by a predetermined shift pitch;
repeating the jetting the polyimide liquid onto the substrate in a scan-coating and the shifting the inkjet head by a predetermined shift pitch until 2N times of scan-coating occurs in which N≧2 and N is a natural number.

8. The method for coating a polyimide layer according to claim 7, wherein the shift pitch is set to be inversely proportional to the number of times of scanning.

9. The method for coating a polyimide layer according to claim 7, wherein the shift pitch is set to a value corresponding to the sum of a nozzle pitch between nozzles and an offset pitch.

10. The method for coating a polyimide layer according to claim 9, wherein the N is two (2) such that the number of times of scan-coating is four (4).

11. The method for coating a polyimide layer according to claim 7, wherein the N is two (2) such that the number of times of scan-coating is four (4).

12. The method for coating a polyimide layer according to claim 7, wherein the N is four (4) such that the number of times of scan-coating is eight (8).
